(19) United States
(12) Patent Application Publication
(10) Pub. No.: US 2003/0065539 A1
(43) Pub. Date: Apr. 3, 2003

(54) Method of locating lost or forgotten insurance, annuity or other investment and pension proceeds

(76) Inventor: Gary M. Kay, Lakeland, FL (US)

Correspondence Address: George A. Bode, BODE & ASSOCIATES, P.C., 2314 Broadway, New Orleans, LA, 70125-4128, US

(21) Appl. No.: 09/967,704

(22) Filed: Oct. 1, 2001

(51) Int. Cl. G06F 17/60

(52) U.S. Cl. 705/4; 705/36

(57) ABSTRACT

A system and method of locating lost or forgotten insurance, annuity or other investment and pension proceeds which requires the inquire to fill out only one form which is then sent electronically or non-electronically to all known benefit companies on the inquirer's behalf. The system receives the responses from the benefits companies and communicates the results to the inquirer. Thereby, the inquirer (attorney, beneficiary, law enforcement agencies, or the insured) can be assured that an exhaustive search of lost or forgotten insurance, annuity or other investment and pension proceeds has been conducted.

### BACKGROUND OF THE INVENTION

1. Field of the Invention

The present invention relates to business methods and, more particularly, to a system and method of locating lost or forgotten insurance, annuity or other investment and pension proceeds. The system can be used manually or electronically.

2. General Background

Many individuals die without leaving clues for their heirs as to life insurance policies, annuities or other investments and/or pensions in which they may have acquired a vested interest. Others lose track of such intangible assets and cannot remember the insurance company, annuity or other investment company, or pension company (all of which are hereinafter sometimes referred to as the “benefit company”) with which they dealt. Currently, there are more than 1700 companies at least 1246 addresses due to mergers, acquisitions, etc.

It is estimated that as much as $1 Billion dollars in life insurance, annuities and pensions are unclaimed and remain sitting in escrow of theses 1700 benefit companies. Some of this money remains unclaimed because the beneficiaries are unaware that the policies exist at the time of death. Since insurance companies are not required to monitor when policy holders dies, unless the beneficiary claims the benefits, such benefits may remain unclaimed.

As can be readily seen, there is a continuing need for a system or method of locating lost or forgotten insurance, annuity or other investment and pension proceeds using the power of the Internet.

Furthermore, there is a continuing need for a system or method of locating lost or forgotten insurance, annuity or other investment and pension proceeds which requires the user to fill out only one form which is then sent to all known benefit companies on the user's behalf. Thereby, the user (attorney, beneficiary, law enforcement agencies, or the insured or “insuree”) can be assured that an exhaustive search of lost or forgotten insurance, annuity or other investment and pension proceeds has been conducted.

As will be seen more fully below, the present invention is substantially different in structure, methodology and approach from that of the business methods.

### SUMMARY OF THE PRESENT INVENTION

The preferred embodiment of method of locating lost or forgotten insurance, annuity or other investment and pension proceeds of the present invention solves the aforementioned problems in a straight forward and simple manner.

Broadly, what is provided is a method of locating lost insurance, annuity or other investments or pension in a population of offsite benefits companies comprising the steps of:

(a) receiving a request for benefits inquiry by an inquirer from a population of users;

(b) establishing an inquiry file for the inquirer which includes subfiles for each benefit company the population of offsite benefit companies;

(c) sending said request for benefits to said each benefit company;

(d) in response of step (c), receiving a response to said request for benefits from at least one benefit companies; and,

(e) communicating results of said response to said inquirer.

The present invention contemplates a method which can be preformed manually or electronically over the Internet.

In view of the above, an object of the present invention is to provide a method of locating lost or forgotten insurance, annuity or other investment and pension proceeds which requires the user to fill out only one form which is then sent to all known benefit companies on the user's behalf. Thereby, the user (attorney, beneficiary, law enforcement agencies, or the insured or “insuree”) can be assured that an exhaustive search of lost or forgotten insurance, annuity or other investment and pension proceeds has been conducted.

The above and other objects and features of the present invention will become apparent from the drawings, the description given herein, and the appended claims.

### BRIEF DESCRIPTION OF THE DRAWING

For a further understanding of the nature and objects of the present invention, reference should be had to the following description taken in conjunction with the accompanying drawings in which like parts are given like reference numerals and, wherein:

FIG. 1 illustrates a general block diagram of the life benefits locating system of the present invention;

FIG. 2 illustrates the inquiry data file and the subfiles of the present invention;

FIG. 3 illustrates the flowchart of the method of locating lost or forgotten insurance, annuity or other investment and pension proceeds of the present invention;

FIGS. 4A and 4B illustrate an exemplary Request for Benefits graphical user interface of the present invention; and,

FIG. 5 illustrates an exemplary inquirer graphical user interface.

### DETAILED DESCRIPTION OF THE PREFERRED EMBODIMENT

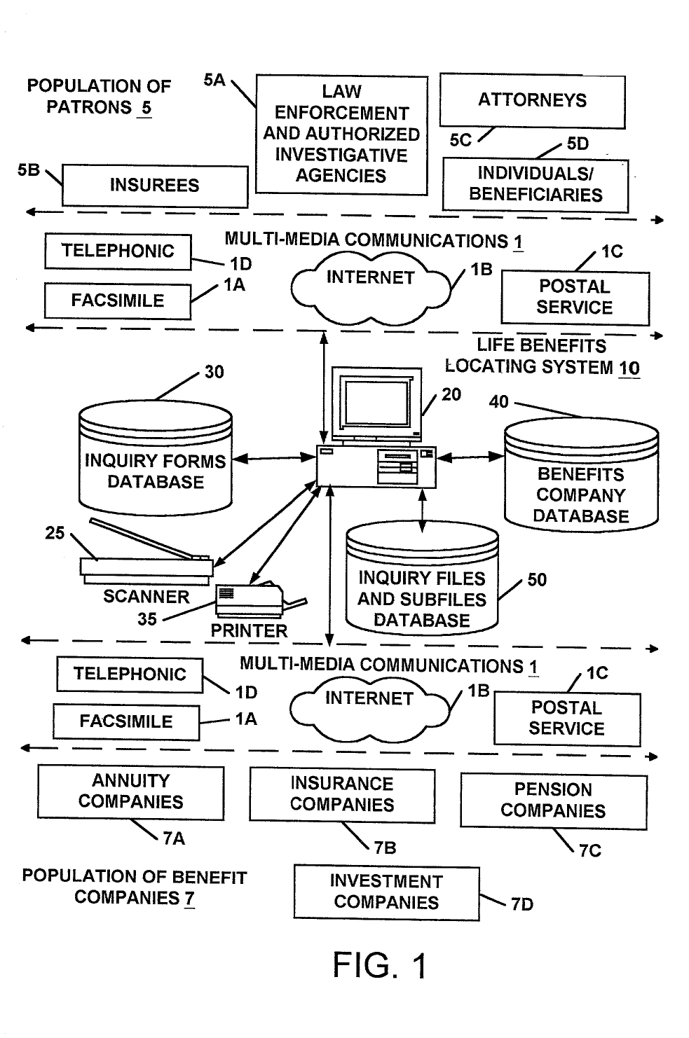

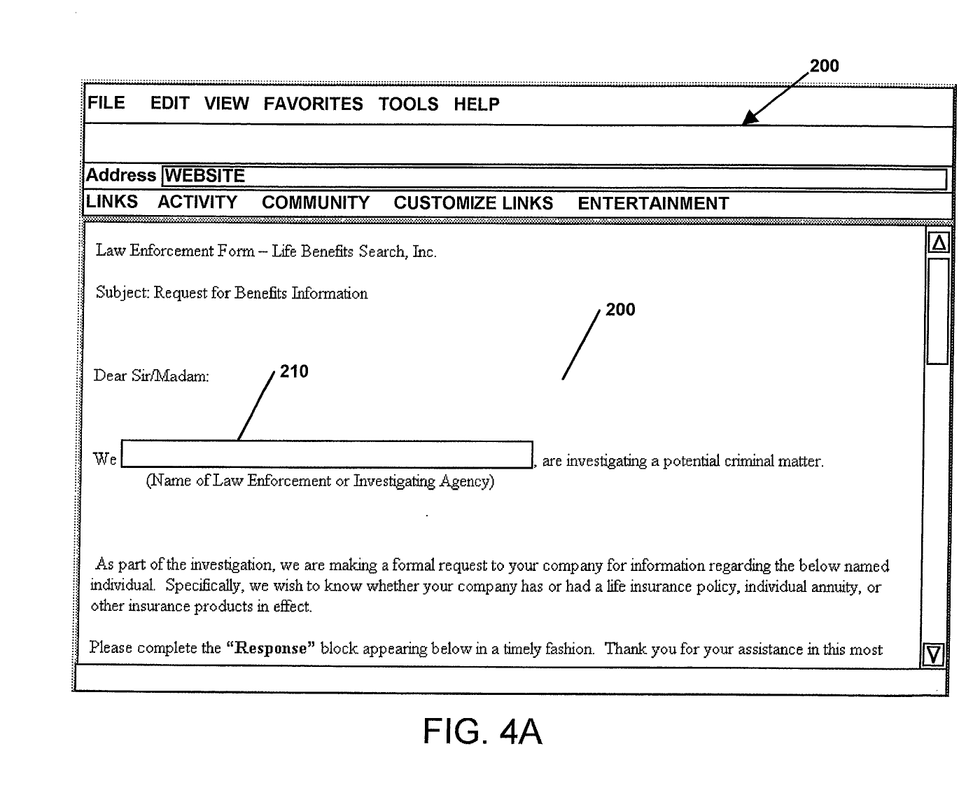

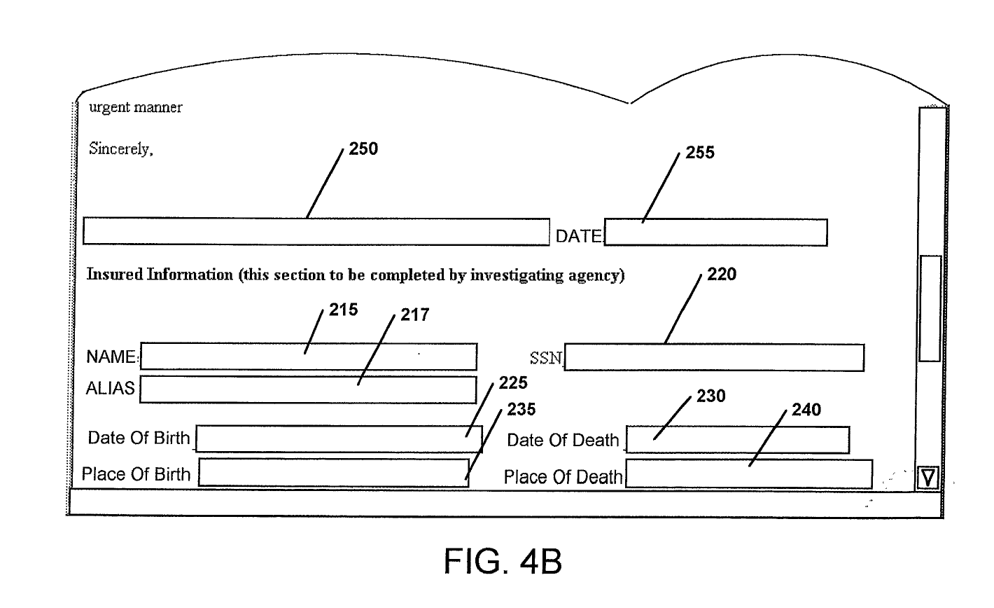

Referring now to the drawings and in particular FIG. 1, a general block diagram of the life benefits locating system 10 (hereinafter referred to as “the system 10”) is illustrated. The system 10 includes a computer or server 20 and stores at least one “Request for Benefits” form 205 (FIGS. 4A and 4B) in inquiry forms database 30 which is adapted to be filled-out by an inquirer and submitted to the system 10 manually or electronically. In one embodiment, the “Request for Benefits” form 205 is submitted with a fee or payment to conduct the locating services.

The system 10 further includes benefit company database 40 and inquiry files and subfiles database 50 in communication with the computer or server 20. The benefit company database 40 includes the addresses to the population of offsite benefits companies 7 including annuity companies 7A, insurance companies 7B, pension companies 7C and other investment companies 7D.

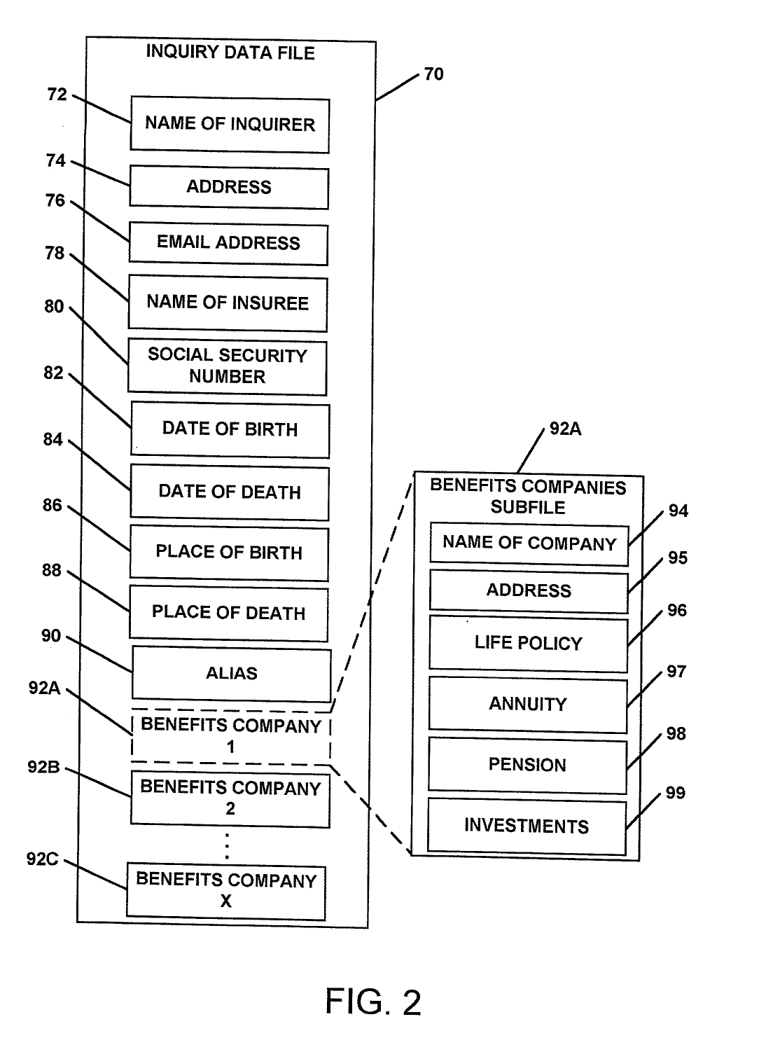

Referring now to FIG. 2, the inquiry data file 70 is shown and is stored in the inquiry data files and subfiles database 50. The inquiry data file 70 is created and stored in database 50 for each received inquiry. The inquiry data file 70 includes a field for the name of the inquirer 72 and may include a first name and a last name, a law firm name or law enforcement or investigative agency. The inquiry data file 70 further includes fields for the address 74 of the inquirer and the email address 76 if applicable. The inquiry data file 70 also includes fields for the name of the insured or “insuree,” policy or instrument holder 78 (hereinafter referred to as the “insuree”), the social security number 80 and aliases 90 such as for a maiden name. Moreover, the inquiry data file 70 includes fields for other pertinent information such as date of birth 82, date of death 84, place of birth 86 and place of death 88.

The data fields may be populated via an online session through the Internet 1B as will be described below.

The inquiry file 70 further includes benefit company subfiles 92A, 92B . . . 92X for each benefit company of the population of offsite benefit companies 7. Since each of the benefit company subfiles 92A, 92B . . . 92X are essentially the same only one will be described in detail. The benefit company subfile 92A includes fields for the name of the company 94 and the address of the company 95. Furthermore, benefit company subfile 92A further includes fields for designating holder of a life policy 96, annuity 97, pension 98 or other investments 99. The data fields 96-99 are populated after the respective benefit company responds to the request.

In operation, the computer or server 20 populates, communicates and updates the inquiry forms database 30, the benefits company database 40 and the inquiry files and subfiles database 50. Furthermore, the computer or server 20 is connected to a scanner 25 to create electronic copies of hard copy “Request for Benefits” forms. Moreover, the computer or server 20 is connected to printer 35 to create a hard copy “Request for Benefits” forms which can be sent via the postal service 1C.

The system 10 is designed to operate as a brick and mortar site and/or a click and mortar site via multi-media communications 1. During brick and mortar operation, an inquirer from a subset of the population of patrons 5 would request a hard copy “Request for Benefits” form via telephonic communications 1D appropriate for their subset. The hard copy “Request for Benefits” form would be sent from the system 10 via facsimile 1A or the postal service 1C. After the inquirer has completed the hard copy “Request for Benefits” form, the inquirer would send the hard copy “Request for Benefits” form to system 10 via facsimile 1A or the postal service 1C.

On the other hand, during the click and mortar operation, an inquirer from a subset of the population of patrons 5 would communicate with the system 10 via the Internet 1B to select a “Request for Benefits” form appropriate for their subset and fill-out such form during an online session over the Internet 1B. After the inquirer has completed the “Request for Benefits” form 205, the inquirer would send the “Request for Benefits” form 205 to system 10 via the internet 1B.

The “Request for Benefits” form 205 can be submitted from an authorized inquirer from a subset of the population of patrons 5. In the exemplary embodiment, the subsets of the population of patrons 5 includes law enforcement and authorized investigative agencies 5A, insurees 5B, attorneys 5C, and individual beneficiaries 5D.

Referring again to the “Request for Benefits” form in stored database 30, each subset of the population of patrons 5 has a distinct “Request for Benefits” form 205 which should be submitted to the system 10. Depending on the subset, different information is necessary when identifying the benefits. For example, a form for the insuree 5B since not deceased would not have information regarding the death of the insuree. However, the form for the beneficiaries 5D, attorneys 5C and law enforcement or investigative agencies 5A may require the formation related to the death of the insuree.

Referring now to FIGS. 4A and 4B, an exemplary Request for Benefits graphical user interface 200 is shown for use in the click and mortar operation of the system 10. In general, the Request for Benefits graphical user interface 200 includes a “Request for Benefits” form 205 having an identification of inquirer data entry field 210. It should be noted that the content of the “Request for Benefits” form 205 is essentially the same for both the hard copy and electronic formats. In the exemplary “Request for Benefits” form 205, the identification would be for a law enforcement or investigative agency 5A. The “Request for Benefits” form 205 identifies the insuree by name in the data entry field 215, aliases in the data entry field 217 and social security number in data entry field 220. The “Request for Benefits” form 205 includes data entry fields 225, 230, 235 and 240 for entering the date of birth, the date of death, the place of birth and the place of death, respectively.

The “Request for Benefits” form 205 further includes data entry fields 250 and 255 for entering the name of the person filing out the data for the law enforcement or investigative agency 5A and the date.

Other forms would include an identification of inquirer data entry field 210 to enter one of an attorney 5C, a beneficiary 5D, or the insuree 5B and may not include data entry field 250. Moreover, the form for an insuree 5B would not include data entry fields 230 and 240.

Once the inquirer submits the “Request for Benefits” form 205 via the “Request for Benefits” graphical user interface 200, the inquiry data file 70 is automatically populated. However, if the “Request for Benefits” form 205 is submitted in a non-electronic format the inquiry data file 70 may be populated via manual data entry.

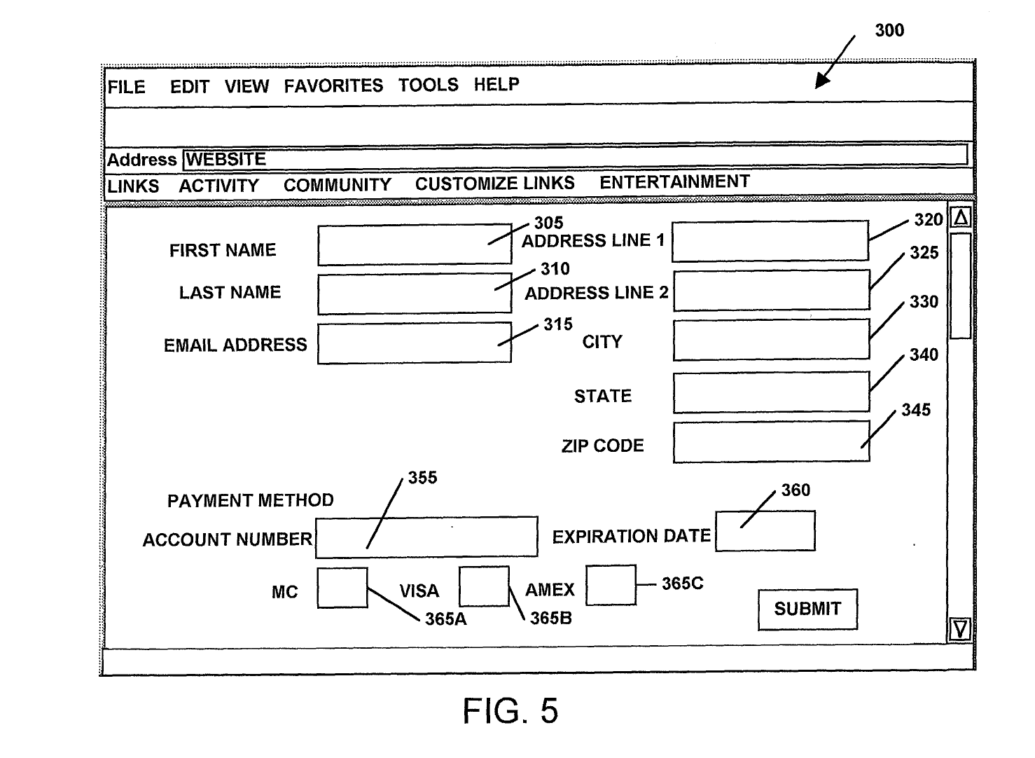

Referring now to FIG. 5, an exemplary inquirer graphical user interface 300 is shown. The inquirer graphical user interface 300 includes data entry fields 305 and 310 for entering online the inquires first and last names, respectively. The inquirer graphical user interface 300 further includes data entry fields 315 for entering an email address and data entry fields 320, 325, 330, 340 and 345 for entering online the inquirers address, city, state and zip code, respectively. In the exemplary embodiment, payment can be submitted online via data entry fields 355 and 360 for entering an account number of a credit card and expiration date, respectively. Moreover, data entry fields 365a, 365b and 365c provide for selection of the type of credit card such as Master Card (MC), Visa, and American Express (AMEX).

The computer or server 20 communicates with the population of offsite benefit companies 7 via multi-media communications 1. After system 10 receives the “Request for Benefits” form 205 and the inquiry data file 70 established, an electronic communication is formatted and assembled to for each and every benefit company of the population of offsite benefit companies 7.

In one embodiment, such offsite communications are sent via the Internet 1B in the form of an e-mail communications to the population of offsite benefits companies 7.

An e-mail communication is first assembled using a standardized electronic-mail transfer protocol which may be sent with a digital signature. Digital signatures are well known for use in encryption and secure communications. Therefore, no further discussion regarding digital signatures are necessary.

The e-mail communication includes an e-mail address header which is automatically populated with the email address of the benefit company in the benefits company database 40 and a text section for insertion of the generic “Request for Benefits” form 205. The e-mail communication would also include YES/NO selection designators (NOT SHOWN) for indicating where the company holds a life policy, annuity or other investments and/or a pension.

The system 10 is equipped with a printer 35 to print the hard copy form letters to the benefit companies 7 which are addressed to the mailing address of the benefit company 7. Additionally, the system 10 may fax the form letters to the benefit companies 7 via facsimile 1A.

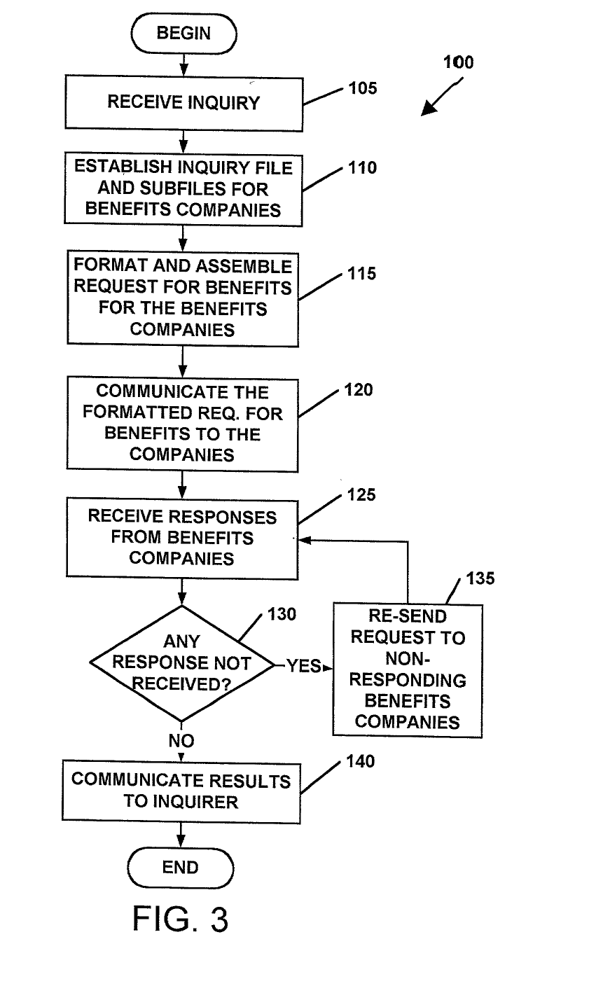

Referring now to FIG. 3, the method of locating lost or forgotten insurance, annuity or other investment and pension proceeds 100 begins at Step 105 where the system 10 will receive a benefits inquiry from a respective inquirer from a subset of the population of patrons 5A, 5B, 5C, 5D and 5E. Step 105 is followed by Step 110 where an inquiry file 70 (FIG. 2) is established wherein the inquiry file 70 includes benefit company subfiles 92A, 92B . . . 92X for each benefit company 7, described above in relation to FIG. 2.

Step 110 is followed by Step 115 where the system 10 formats and assembles a Request for Benefits communication to the population of benefits companies 7. For example, the Request for Benefits communication may be in the form of an email communication, postal service mail or facsimile. Step 115 is followed by Step 120 where the system 10 communicates or sends the Request for Benefits communication to the population of benefit companies 7 stored in benefits company database 40. Step 120 is followed by Step 125 where the system 10 receives responses from the population of benefit companies 7.

Step 125 is followed by decision Step 130 where a determination is made whether any of the benefit companies 7 are not responding. If the determination at Step 130 is YES, Step 130 is followed by Step 135 where the request is resent to the non-responding benefits company(s). For example, if any of the benefit companies of the population of benefit companies 7 do not reply such companies will be re-contacted by a letter or telephone call to provoke a response. Step 135 is followed by Step 125 described above.

In the event a benefits company does not respond after at least one subsequent request, the insurance commissioner of the state where the benefits company operates will be notified.

If the decision is NO at Step 130, then Step 130 is followed by Step 140 where the inquirer is communicated the results of the benefits request.

The responses from each benefit company 7 is entered or automatically populated into the benefit company subfiles 92A, 92B . . . 92X at data fields 96-99. Thereafter, the inquirer is communicated the results. For example, the results may be communicated via at least one email communication or they may be posted onsite at the system 10 (website) in a online folder accessible by the inquirer via the Internet 1B. Alternately, the results may be communicated by other multi-media communications 1 including facsimile 1A and postal service 1C.

Because many varying and differing embodiments may be made within the scope of the inventive concept herein taught and because many modifications may be made in the embodiment herein detailed in accordance with the descriptive requirement of the law, it is to be understood that the details herein are to be interpreted as illustrative and not in a limiting sense.

What is claimed as invention is:

1. A method of locating lost insurance, annuity or other investments or pension in a population of offsite benefits companies comprising the steps of:
(a) receiving a request for benefits inquiry by an inquirer from a population of users;
(b) establishing an inquiry file for the inquirer which includes subfiles for each benefit company the population of offsite benefit companies;
(c) sending said request for benefits to said each benefit company;
(d) in response of step (c), receiving a response to said request for benefits from at least one benefit companies; and,
(e) communicating results of said response to said inquirer.

2. The method of claim 1, wherein the step (a) includes receiving electronically via Internet.

3. The method of claim 1, wherein the step (a) includes receiving one of facsimile, postal service or the Internet.

4. The method of claim 1, wherein said inquirer is from a subset of the population of patrons wherein said subset includes one of law enforcement or authorized investigative agencies, insurees, attorneys and individual beneficiaries.

5. The method of claim 1, wherein:
the population of offsite benefit companies includes insurance companies, pension companies and annuity or other investment companies;
the step (c) includes:
(c1) communicating said request for benefits to said insurance companies;
(c2) communicating said request for benefits to said pension companies; and,
(c3) communicating said request for benefits to said annuity or said other investment companies.

6. The method of claim 1, wherein the step (a) includes receiving a notarized request for benefits form from said inquirer.

7. The method of claim 1, further comprising the steps of:
(f) after the step (c), determining a benefit company is non-responsive;
(g) in response to step (f), re-sending said request for benefits to the non-responsive benefit company.

8. The method of claim 1, wherein the step (c) includes receiving via the Internet.

9. The method of claim 8, wherein:
the step (c) includes the step of:
(c1) formatting said request for benefits into an e-mail communication assembled using a standardized electronic-mail transfer protocol;
the step (d) includes the step of:
(d1) receiving an e-mail communication response to said request for benefits with response data.

10. The method of claim 1, further comprising prior to step (e) the steps of:
(f) populating said subfiles for said each benefit company with said response data;
wherein said step (e) includes the step of:
(e1) communicating said response data.

11. The method of claim 10, wherein said communicating in step (e1) is performed electronically via Internet.

12. The method of claim 10, wherein said communicating in step (e1) is performed via one of facsimile, telephonic or Internet.

13. The method of claim 1, further comprising the steps of:
(f) prior to step (a), displaying a graphical user interface of a request for benefits form; and,
(g) after step (f), receiving data representative of one of a deceased individual, an insuree or instrument holder; and,
wherein the step (b) includes the step of:
(b1) automatically populating said inquiry file with the received data in the step (g).

14. The method of claim 13, further comprising the steps of:
(f) prior to step (b), receiving payment for performing steps (c)-(e).

15. The method of claim 13, wherein said receiving step (f) is performed electronically during an online session.

16. A method of locating lost insurance, annuity or other investments or pension in a population of offsite benefits companies comprising the steps of:
(a) receiving a request for benefits inquiry by an inquirer from a population of users;
(b) establishing an inquiry file for the inquirer which includes subfiles for each benefit company the population of offsite benefit companies;
(c) sending said request for benefits to said each benefit company;
(d) in response of step (c), receiving a response to said request for benefits from at least one benefit companies;
(e) communicating results of said response to said inquirer;
(f) populating said subfiles for said each benefit company with said response data;
wherein said step (e) includes the step of:
(e1) communicating said response data;
(g) prior to step (a), displaying a graphical user interface of a request for benefits form; and,
(h) after step (g), receiving data representative of one of a deceased individual, an insuree or instrument holder; and,
wherein the step (b) includes the step of:
(b1) automatically populating said inquiry file with the received data in the step (h).

17. The method of claim 16, further comprising the steps of:
(i) after the step (c), determining a benefit company is non-responsive; and,
(j) in response to step (i), re-sending said request for benefits to the non-responsive benefit company.

18. A method of locating lost insurance, annuity or other investments or pension in a population of offsite benefits companies comprising the steps of:
(a) receiving a request for benefits inquiry by an inquirer from a population of users, said request being received electronically via Internet;
(b) establishing an inquiry file for the inquirer which includes subfiles for each benefit company the population of offsite benefit companies;
(c) sending said request for benefits to said each benefit company;
(d) in response of step (c), receiving a response to said request for benefits from at least one benefit companies;
(e) communicating results of said response to said inquirer;
(f) populating said subfiles for said each benefit company with said response data;
wherein said step (e) includes the step of:
(e1) communicating said response data;
(g) prior to step (a), displaying a graphical user interface of a request for benefits form;
(h) after step (g), receiving data representative of one of a deceased individual, an insuree or instrument holder;
wherein the step (b) includes the step of:
(b1) automatically populating said inquiry file with the received data in the step (h);
(i) prior to step (b), receiving payment electronically during an online session for performing steps (c)-(e); and,
(j) after the step (c), determining a benefit company is non-responsive; and,
(k) in response to step (j), re-sending said request for benefits to the non-responsive benefit company.
